(19) United States
(12) Patent Application Publication
(10) Pub. No.: US 2026/0036699 A1
(43) Pub. Date: Feb. 5, 2026

(54) METHOD AND SYSTEM FOR HIGH-QUALITY IONOSPHERE SPATIAL INTERPOLATION IN REGIONAL NETWORKS FOR FAST PRECISE SERVICES

(71) Applicant: TOPCON POSITIONING SYSTEMS, INC., Livermore, CA (US)

(72) Inventors: Kirill Sergeevich KOLOSOV, Mirandola (IT); Dmitry Pavlovich NIKITIN, Mirandola (IT); Evgeny Dmitrievich MATVEEV, Khimki (RU)

(73) Assignee: TOPCON POSITIONING SYSTEMS, INC., Livermore, CA (US)

(21) Appl. No.: 19/237,156

(22) Filed: Jun. 13, 2025

Related U.S. Application Data
(60) Provisional application No. 63/677,664, filed on Jul. 31, 2024.

(51) Int. Cl. G01S 19/07; G01S 19/20

(52) U.S. Cl. CPC G01S 19/072; G01S 19/20

(57) ABSTRACT

A method and system for high-quality ionosphere spatial interpolation is designed to improve outlier detection and accuracy estimation in regional networks to accelerate convergence of PPP-RTK positioning services. STEC estimations from a regional receiver network undergo a sequence of anomaly detection steps including jump detection by Alpha-Beta filtering, outlier detection by a posteriori residuals from differenced STEC spatial approximation and by cross-validation of differenced STEC values. The method further includes generating an estimation of ionosphere activity indicator which is further used in outlier detection. On-the-fly estimation of the indicator provides more robust STEC outliers detection because it accounts for systematic periodic changes in ionosphere activity and for spatial correlation of the ionosphere.

### CROSS-REFERENCE TO RELATED APPLICATIONS

This application claims the benefit of priority from U.S. Provisional Patent Application No. 63/677,664, filed Jul. 31, 2024; the contents of which are incorporated herein by reference in their entireties.

### FIELD OF THE INVENTION

The present disclosure relates generally to positioning using Global Navigation Satellite Systems (GNSS), and more particularly to spatial interpolation in regional networks for fast precise services.

### BACKGROUND

Global Navigation Satellite Systems (GNSS) use signals from satellites received by a GNSS receiver in order to determine a location of the antenna of a GNSS receiver. Such systems can determine the position of the antenna with a specific accuracy. The accuracy of position determination by GNSS systems is often insufficient for particular applications. The accuracy of position determination can be increased using methods such as precise point positioning (PPP). However, convergence times for PPP methods are often excessive for certain applications. What is needed is a PPP method with low convergence times that allows for fast high accuracy position determination.

### SUMMARY

A method for precise point positioning includes the step of receiving Slant Total Electron Content (STEC) estimations from a network of Global Navigation Satellite (GNSS) receivers.

A predicted STEC is generated based on the STEC estimations and a differenced STEC spatial approximation is generated based on the predicted STEC. A faulty satellite flag is raised in response to detection of STEC outliers based on a posteriori residuals of the differenced STEC spatial approximation. A faulty STEC estimations flag is raised in response to cross-validation of STEC values. Grided STEC parameters are generated based on interpolation and accuracy estimation. High quality fault-free grided STEC parameters are transmitted to a Global Positioning System user receiver to provide fast precise point positioning solution.
In one embodiment, the predicted STEC is generated by the STEC predictor module based on the STEC estimations and a priori residuals of the predictor's filter (a modified Alpha-Beta filter). These predicted/filtered STEC values are converted into first differences, which are further processed by the Differenced STEC approximation module where a robust spatial approximation with iterative re-weighting is applied to the array of first differences (sat−ref. sat). On the basis of a posteriori residuals obtained as by-products of this approximation, the first step of the detection of anomalies is performed. A faulty satellite flag is raised in response to residuals values exceeding the threshold. At the second detection step, cross-validation of STEC values is performed and a faulty STEC estimation flag is raised in response to high discrepancies between estimated differenced STECs and values interpolated between adjacent stations. GRID STEC parameters are generated based on STEC interpolation and accuracy estimation. The GRID STEC parameters are transmitted to the mixer and further on via Internet, having been mixed with a global set of SSR corrections, to a SSR2OSR module of Global Positioning System user receivers. In one embodiment the method further includes generating an estimation of ionosphere activity indicator, wherein the detection of STEC outliers and cross-validation of STEC values are further based on the ionosphere activity indicator. In one embodiment, estimating of ionosphere activity includes generating VTEC and estimating biases. Based on a posteriori residuals of the bias estimation process, hourly empirical histograms are generated. The Median Absolute Deviation of the empirical histogram is converted into an ionosphere activity indicator which is further used in outlier detection and cross-validation. In one embodiment, the method includes two versions. The first version includes calculations regarding VTEC and biases estimations, hourly histogram update, MAD estimator (first version which is shown in FIG. 6) and ionosphere activity is estimated on the fly in hourly intervals. However, during the initialization of the estimation process, the ionosphere activity estimate should be provided externally based on previous research (second version which is shown in FIG. 2). The generating a predicted STEC can comprise detecting STEC outliers in the STEC estimations, filtering out the detected STEC outliers in the STEC estimations and replacing them with extrapolated values, and replacing short time gaps with extrapolated values. The generating a predicted STEC can comprise filtering STEC estimations using a modified Alpha-Beta filter. The cross-validation of STEC values can comprise comparing STEC values estimated on a particular station with STEC values interpolated between adjacent stations. The method for fast precise service can further comprise generating an estimation of ionosphere activity indicator, wherein the detection of STEC outliers and cross-validation of STEC values are further based on the estimation of ionosphere activity indicator. The generating an estimation of ionosphere activity indicator can comprise generating a posteriori residuals of a VTEC and biases estimation process, generating hourly empirical histograms based on the a posteriori residuals, and estimating a time-dependent ionosphere activity indicator based on hourly empirical histograms. The generating a faulty satellite flag in response to detection of STEC outliers can be based on the a posteriori residual of differenced STEC spatial approximation process. A faulty estimation flag can be raised based on the cross-validation of STEC values and the ionosphere activity indicator.

An apparatus having memory storing computer program instructions for precise point positioning and a computer readable medium storing instructions for precise point positioning are also described herein.

### BRIEF DESCRIPTION OF THE DRAWINGS

FIG. 1 shows a PPP-RTK correction service system according to one embodiment;

FIG. 2 shows a high-level block diagram of a main common part of ionosphere data processing algorithm according to one embodiment (both first and second versions).

FIG. 3 shows an example of Slant Total Electron Content (STEC) estimation by STEC predictor module for a Global Positioning System satellite G19 and demonstrates handling of a time gap and anomalies (e.g., outliers);

FIG. 4 shows a Slant Total Electron Content (STEC) predictor anomalies rejector according to one embodiment;

FIG. 5A shows a graph of longitude vs. latitude representing interpolation accuracy of Global Positioning System (GPS) satellite G17 in Total Electron Content (TEC) units (TECU), where the mean elevation is 18.1 grad;

FIG. 5B shows a graph of longitude vs. latitude representing interpolation accuracy of Global Positioning System (GPS) satellite G15 in Total Electron Content (TEC) units (TECU), where the mean elevation is 27.7 grad;

FIG. 5C shows a graph of longitude vs. latitude representing interpolation accuracy of Global Positioning System (GPS) satellite G10 in Total Electron Content (TEC) units (TECU), where the mean elevation is 12.1 grad;

FIG. 5D shows a graph of longitude vs. latitude representing interpolation accuracy of Global Positioning System (GPS) satellite G06 in Total Electron Content (TEC) units (TECU), where the mean elevation is 10.7 grad;

FIG. 6 shows an implementation of the first version ionosphere data processing algorithm according to one embodiment;

FIG. 7 shows a graph of a posteriori Vertical Total Electron Content (VTEC) residuals during night hours;

FIG. 8 shows a graph of a posteriori VTEC residuals during morning hours; and

FIG. 9 shows a high-level block diagram of a computer to implement the methods, algorithms, and techniques described herein according to one embodiment.

### DETAILED DESCRIPTION

The present disclosure pertains to high-quality ionospheric interpolation with a particular focus on accelerating convergence times as compared to classical precise point positioning (PPP) methods. In one embodiment, the present disclosure focuses on issues prevalent in sparse regional networks, during periods of active ionospheric disturbances, and in the presence of anomalies during Slant Total Electron Content (STEC) estimation. The implementation of ionospheric models and algorithms designed for adaptive and precise interpolation are described herein. This can be important for the operational effectiveness of fast regional PPP techniques and Real-time kinematic-precise point positioning (RTK-PPP) systems. The ionospheric data processing described herein can be used to improve interpolation quality and can significantly enhance the reliability and accuracy of geospatial positioning services.

The reliability of advanced fast regional Precise Point Positioning (PPP) services depends on the quality of ionospheric interpolation (particularly in challenging scenarios such as sparse network coverage), ionospheric activity and anomalies in STEC data. The development of robust ionospheric models and algorithms which are capable of providing high-quality interpolation results are described herein. In one embodiment, the core of an approach involves enhancing the detection and exclusion of STEC outliers, and employing dynamic interpolation algorithms that adjust in real-time to ionospheric variations. Methods described herein can be used to refine ionospheric modeling by integrating advanced algorithmic techniques and real-time data analytics. The techniques described herein improve PPP performance and provide the potential for rapid convergence and increased positioning accuracy under diverse and demanding geospatial conditions.

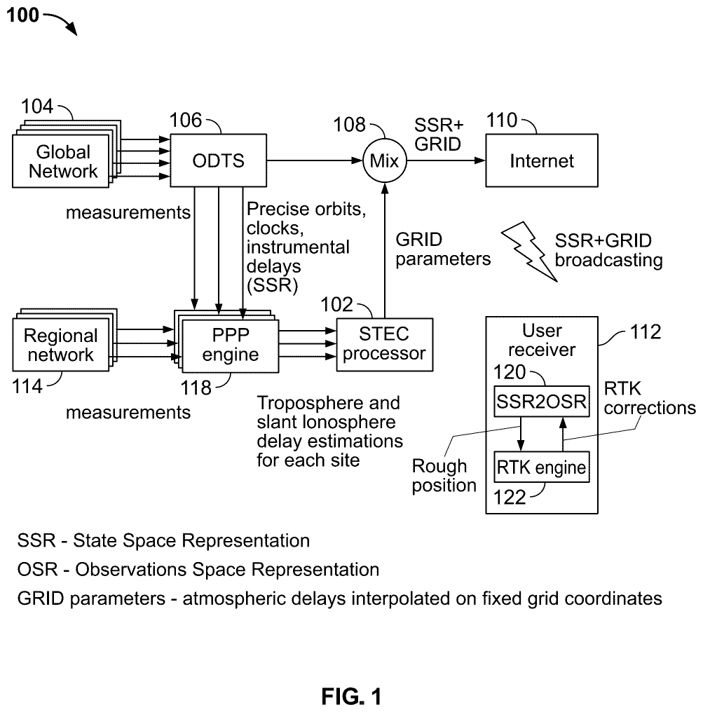

RTK-PPP services benefit from both high precision of carrier-phase measurements and global coverage of PPP services. In one embodiment, global corrections that include information regarding precise satellite clocks and orbits are used. Precise atmospheric delays (ionospheric and tropospheric) are estimated by and received from a regional network which includes multiple base stations. A combination of a regional correction service and global corrections (satellite clocks and orbits) is used. The regional correction service calculates atmosphere correction parameters with the use of the global corrections. Using both global and regional corrections, users can create their own virtual reference stations and use RTK algorithms for precise navigation. To accomplish this, the regional correction service should provide high precision corrections, mean error not exceeding a few centimeters. Atmospheric corrections are divided into two parts—troposphere and ionosphere. With respect to cm-level precision of regional correction services, the most challenging task is to estimate spatial distribution of total electron concentration (TEC) in the ionosphere. The implementation of the improved ionosphere data processing algorithm described herein for precise ionosphere interpolation (both first and second versions) begins with the STEC processor 102 shown in FIG. 1.

In one embodiment, the STEC processor is hardware configured for reliable real-time estimation, interpolation, and outlier detection in ionosphere data and its covariance estimation for at least one regional network using precise satellites orbits, clocks, and measurement biases. FIG. 1 shows a correction service system 100 including STEC processor 102. A global network 104 generates and transmits measurements to ODTS (orbit determination and time synchronization) module 106. Measurements transmitted from the global network 104 to ODTS module 106 include raw pseudoranges, phase and Doppler shift observations for all receivers that constitute the global network 104. ODTS module 106 generates and transmits precise orbit information, clock information, and instrumental delays (i.e., a state space representation referred to as an “SSR”) to precise point positioning (PPP) engine 118. PPP engine 118 receives measurements from regional network 114 and generates and transmits troposphere and slant ionosphere delay estimates for each site of regional network 114 to STEC processor 102. Measurements transmitted from the regional network 114 to PPP engine 118 include raw pseudoranges, phase and Doppler shift observations for all receivers that constitute the regional network 114.

SSR information is also transmitted from ODTS module 106 to mixer 108 where it is mixed with GRID parameters (i.e., atmospheric delays interpolated onto fixed grid coordinates) generated by and received from STEC processor 102. Mixer 108 outputs SSR and GRID parameters to user receiver 112 over internet 110 (e.g., via broadcast, dedicated communication channel, etc.). In one embodiment, SSR and GRID parameters are received by SSR2OSR 120 which generates RTK corrections in conventional Radio Technical Commission for Maritime Services (RTCM) format and transmits them to RTK engine 122 which transmits rough position information back to SSR2OSR 120. SSR2OSR 120 can be a module within user receiver 112 which converts State Space Representations (SSR) corrections into conventional RTCM-type Observation Space Representation (OSR) corrections with the use of a rough user position as an additional input. The function of SSR2OSR is to create a Virtual Reference Station (VRS) which imitates a closely located physical base station. The position of a VRS is set to a roughly estimated user position. The corrections generated and transmitted (or otherwise distributed) by a VRS are calculated on the basis of SSR information (i.e., precise orbits and clocks plus measurement biases) and atmospheric corrections (troposphere and ionosphere) interpolated to the VRS position. The output of SSR2OSR imitates the stream of RTCM messages which a physical base station would have transmitted and can be directly used as input by the RTK engine 122. The RTK engine 122 can be a module within user receiver 112 which calculates precise user position based on joint processing of rover pseudoranges and phase measurements together with local corrections generated by a closely located base station with a precisely known position (or by a VRS as its imitation). Due to relatively moderate degree of space decorrelation of all GNSS errors, OSR corrections generated by a physical base station located at a baseline distance of 10-20 km from the rover sufficiently compensate rover errors. Remaining errors are of the order of a few centimeters, which allow double-differenced phase ambiguities to be resolved. With double-differenced phase ambiguities resolved, RTK positioning algorithm switches to the fixed mode which is characterized by cm-level positioning errors. The functioning of RTK algorithms with VRS-generated OSR corrections is similar to their operation with physical base stations. However, there is a difference. RTK errors with a physical base station increase with the baseline distance. But with a VRS the formal baseline distance is always small and the error budget of RTK-VRS depends upon the quality of SSR corrections and atmospheric corrections. RTK errors with a VRS as a source of corrections increase with the sparsity of regional network and they also significantly depend upon the quality and sophistication of interpolation algorithms, both for troposphere and ionosphere delays.

In one embodiment, PPP engine 118 is used to continuously estimate slant total electron concentration (STEC) for each receiver-satellite pair. These STEC estimations are aggregated in STEC processor 102. STEC values received from all available receivers of regional network 114 during a measurement epoch are processed by the main workflow sequence of the ionosphere data processing algorithm (200). In one embodiment, STEC processor 102 is located in a base station that receives data and transmits GRID parameters. STEC processor 102 can also be a stand-alone device or integrated into other devices and systems.

In one embodiment, a spatial Gaussian process is used with predefined ionosphere behavior (i.e., 2^{nd} version of the algorithm) or estimated-on-the-fly ionosphere parameters (i.e., 1^{st} version) to approximate and interpolate ionosphere delays and transmit them to SSR2OSR utility in the format of GRID-STEC parameters. Predefined ionosphere behavior (2^{nd} version) could be estimated in previous research with the use of archived datasets from different regions. In the case of on-the-fly estimation (1^{st} version), improvements in terms of outlier detection and interpolation quality are provided.

Some key features of the 1^{st} version of the ionosphere data processing algorithm include the ability to add receivers to (or remove them from) the network 114 on-the-fly. The first version of the ionosphere data processing algorithm also provides more robust STEC outliers detection, because it accounts for systematic periodic changes in ionosphere activity and for spatial correlation of the ionosphere. The first version of the ionosphere data processing algorithm also provides improved accuracy of ionosphere interpolation for sparse regional networks and/or during active ionosphere periods. The first version of the ionosphere data processing algorithm also provides covariance estimates of interpolated ionosphere delays. These covariance estimates are computed in interpolation and accuracy estimation module 210 (step 4 of algorithm 5). The covariance estimation depends upon ionospheric activity indicator C₀(t). The higher is ionospheric activity, the higher is the indicator C₀(t), and the higher are interpolation accuracy covariances Cᵤ^{j}.

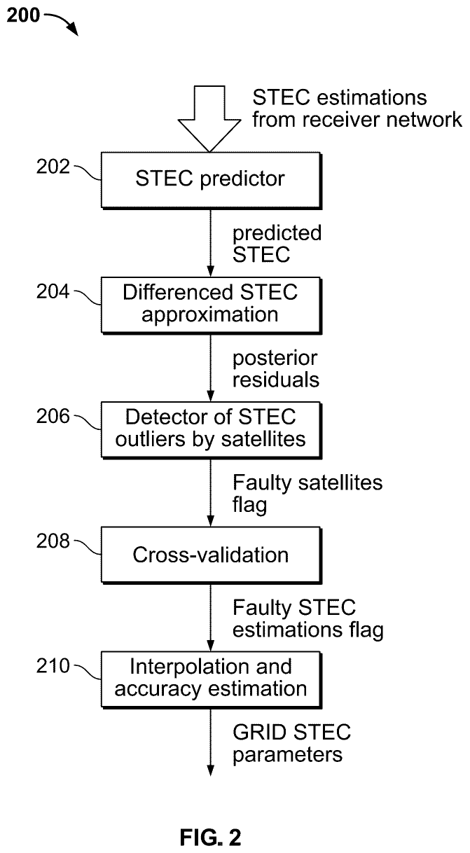

A high-level block diagram of the implementation of the main ionosphere data processing algorithm 200 that is run on STEC processor 102 (and is common for 1^{st} and 2^{nd} versions) is shown in FIG. 2. The processing of STEC estimations from a receiver regional network 114 shown in FIG. 1 begins with STEC predictor module 202. STEC predictor module 202 generates a predicted STEC which is used by the next-in-line differenced STEC approximation module 204 to generate a posteriori residuals. These a posteriori residuals are used by the detector of STEC outliers by satellite 206 which generates and outputs faulty satellite flags in response to determining that STEC outliers are associated with one or more global positioning satellites. The faulty satellite flags are further transmitted to cross-validation module 208 which generates faulty STEC estimation flag. The faulty STEC estimation flag is transmitted to interpolation and accuracy estimation module 210 which generates GRID-STEC parameters which are then transmitted to user receiver 112 (via the mixer 108 and Internet 110, as shown in FIG. 1).

In one embodiment, the estimated STEC general model is formulated:

$$S T E {C}_{i}^{j} = {m}_{i}^{j} \cdot V T E {C}_{i}^{j} + {Δ}_{i} + {μ}^{j} + {ε}_{i}^{j}$$

$$where :$$

$${m}_{i}^{j} - ionosphere mapping function .$$

$$V T E {C}_{i}^{j} - Vertical Total Electron Concentration .$$

$${Δ}_{i} - receiever hardware bias .$$

$${μ}^{j} - satellite hardware bias .$$

$${ε}_{i}^{j} - estimation error , including noise and mulitpath errors ( assumed to$$

$$be uncorrelated ) .$$

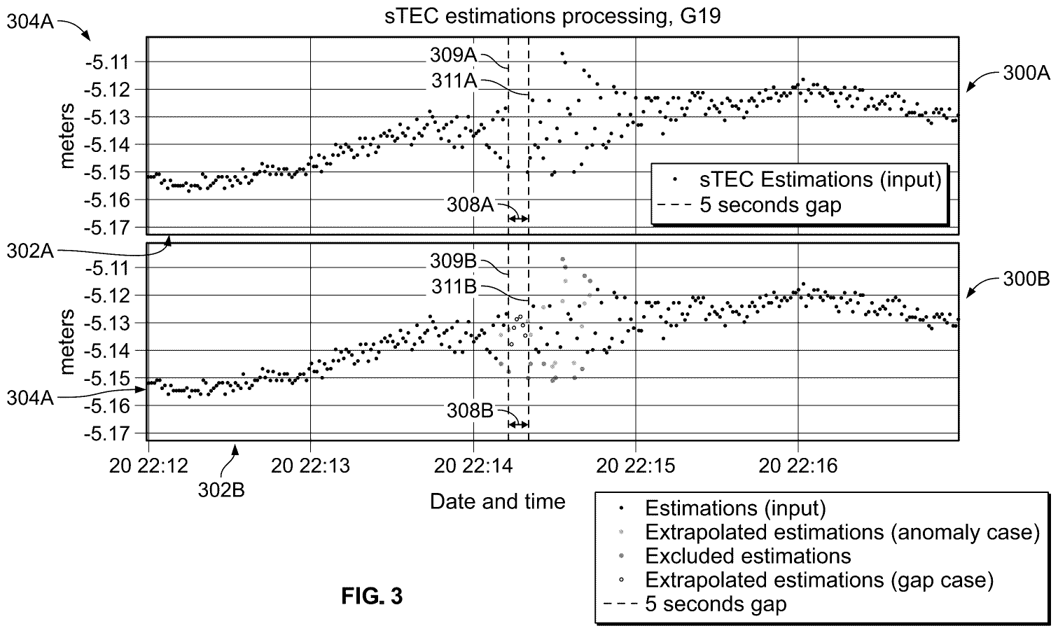

With respect to STEC predictor module 202 shown in FIG. 2, when the aggregation of data from the regional network experiences connectivity issues, gaps in data communication streams can significantly affect the performance of ionosphere interpolation and, as a result, the performance of fast convergence PPP or RTK-PPP services. STEC predictor module 202 addresses these issues by utilizing the concept that STEC estimations have strong autocorrelation. STEC predictor module 202 is configured to compensate for short time gaps as well as for short bursts of outliers in STEC data streams. An example of how a five-second time gap in a stream is addressed is presented in graphs 300A and 300B of FIG. 3, Graph 300A has date and time on the horizontal axis 302A and STEC in meters on the vertical axis 304A. Graph 300A shows the stream of STEC estimations at the input of the STEC predictor module 202 (i.e., the data stream that we would have had without the STEC predictor). Graph 300B has date and time on the horizontal axis 302B and STEC in meters on the vertical axis 304B. Graph 300B shows the results of data conditioning performed by the STEC predictor module 202. Vertical lines 309A and 311A mark the time gap 308A of five seconds (from 22:14:14 to 22:14:19). This time gap is clearly seen in the top plot while in the bottom plot it is filled with dots that represent extrapolated estimations provided by the STEC predictor.

STEC estimations may have low accuracy and contain jumps, outliers or other unexpected errors. STEC Predictor module 202 provides for detection and filtering out of these STEC outliers from further processing if anomalies are present for a short period of time. The operation of STEC predictor module 202 is described in Algorithm 1 below.

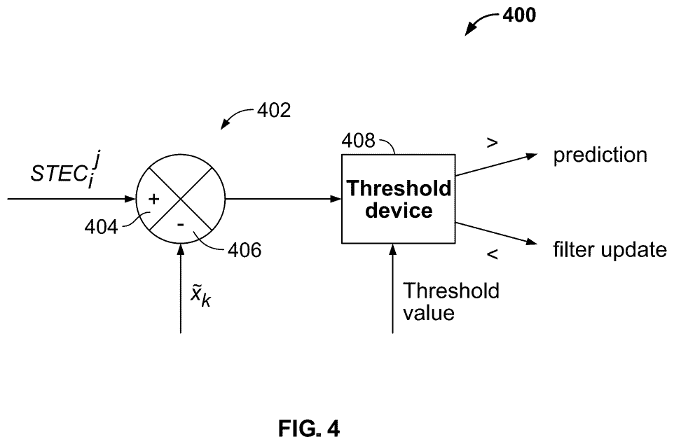

Algorithm 1. STEC Predictor algorithm

| In | undifferenced STEC: STECᵢ^{j}, for one satellite j and one receiver i |
|---|---|
| | STEC estimation error RMS: σᵢ^{j} |
| Out | filtered (or extrapolated) STECᵢ^{j} |
| | Algorithm actions sequence |
| 1 | Filtering low accuracy observations: if σᵢ^{j}, is above the threshold, current observation is |
| | skipped, otherwise current observation goes to filter input. |
| 2 | Filtering STEC using modified Alpha-Beta filter (simplified Kalman filter approach for |
| | uniform and equally accurate over a certain time interval measurements): |
| | prediction step: \tilde{v}ₖ = \hat{v}ₖ₋₁, \tilde{x}ₖ = \hat{x}ₖ₋₁ + ΔT\tilde{v}ₖ |
| | $calculate residual between estimated STEC and predicted value : {\hat{r}}_{k} = S T E {C}_{i}^{j} - {\tilde{x}}_{k}$ |
| | reject anomalies according to the logical scheme shown on the Figure 4. |
| | Where ΔT - is time difference between last filter update timestamp and current processing |
| | timestamp. |
| | $Update step : {\hat{r}}_{k} = S T E {C}_{i}^{j} - {\tilde{x}}_{k} , {\hat{x}}_{k} = {\tilde{x}}_{k} + ( α ) {\hat{r}}_{k} , {\hat{v}}_{k} = {\tilde{v}}_{k} + ( \frac{β}{Δ T} ) {\hat{r}}_{k}$ |
| 3 | $Extrapolate STEC estimation {STEC}_{i}^{j} = {\hat{x}}_{k} + Δ T {\tilde{v}}_{k}$ |

The example of handling a burst of outliers is also presented in FIG. 3. In the top plot we see a group of outliers, i.e. values with highest deviations from a normal range (maximal and minimal values in the central part). In the bottom plot these dots are marked in red to show that the outliers are detected. Red dots do not belong to the STEC predictor output; they indicate the data which are filtered out. In fact, detected anomalies are treated similarly to time gaps; they are also filled with extrapolated values marked with green color in the plot. In other words, STEC predictor replaces outliers (red dots) with extrapolated values (green dots).

FIG. 4 shows a STEC predictor anomalies rejector 400 in which STECᵢ^{j} is input to positive input 404 of summer 402 and \tilde{x}ₖ is input to negative input 406 of summer 402. Summer 402 outputs the sum to threshold device 408 which also receives a threshold value from the configuration parameter set to compare to the output of summer 402. If the output of summer 402 is greater than the threshold value, threshold device 408 outputs a prediction. If the output of summer 402 is less than the threshold value, it outputs a filter update. FIG. 4 shows summer 402 which is part of the STEC predictor. The summer inputs are: (+) undifferenced estimated STEC 404 and (−) STEC value predicted at the previous epoch 406. The output is difference of two inputs. This output goes as input in the threshold device 408. The threshold device verifies whether its input is not greater than the preconfigured threshold. If YES, the predicted STEC is further extrapolated; if NO, the normal step of Alpha-Beta filter update is made and the filtered STEC is outputted.

In one embodiment, a differenced STEC approximator is used to perform differenced STEC approximation operation 204 (shown in FIG. 2). In one embodiment, additional processing pertains to differenced STEC (i.e., satellite−ref. satellite). The satellite that is transmitting signals received by the greatest number of receivers in a regional network is selected, according to one embodiment, as the reference satellite. In one embodiment, the differenced STEC approximation is performed independently for each of a plurality of global positioning satellites in the network using algorithm 2 shown below.

Algorithm 2. Robust approximation with iterative reweighting (204)

| | |
|---|---|
| In | $differenced STEC : S T E {C}_{i}^{j , r e f} = S T E {C}_{i}^{j} - S T E {C}_{i}^{r e f} , for one satellite j and all$ |
| | receivers. |
| | geodetic coordinates of receiver in the regional network: Latᵢ and Lonᵢ |
| | threshold TH for the measurements de-weight procedure. |
| Out | approximation surface coefficients of regional ionospheric model: |
| | ${c}_{00}^{j} , {c}_{01}^{j} , {c}_{10}^{j} , {c}_{11}^{j} , {c}_{02}^{j} , {c}_{20}^{j} ,$ |
| | $differenced STEC a posteriori residuals {d}_{i}^{j , r e f}$ |
| | Algorithm actions sequence |
| 1 | $Collect estimated differenced {STEC}_{i}^{j , ref} values into one measureements vector z :$ |
| | ${z}_{i} = S T E {C}_{i}^{j , ref}$ |
| 2 | Construct observation matrix H. Each row of the H matrix consists of the coefficients: |
| | hᵢ = [1, Latᵢ, Lonᵢ, LatᵢLonᵢ, Latᵢ² , Lonᵢ²] |
| 3 | Set initial weights for all measurements: w(:) = 1; |
| 4 | Calculate weight matrix W: W = diag(w)/sum(w); |
| 5 | Calculate state estimation: x = (H′*W\hat{ }2*H)\H′*W\hat{ }2*z; |
| 6 | Calculate posterior residuals: r = abs(z − H*X); |
| 7 | Identify outliers: badmeas = (r > TH); |
| 8 | Update weights: |
| | w(:) = 1; |
| | w(badmeas) = sqrt(2*r(badmeas)*TH − TH\hat{ }2)./r(badmeas); |
| 9 | Repeat steps 4-8 not more than 3 times. |
| 10 | Calculate a posteriori residuals: |
| | ${d}_{i}^{j , ref} = S T E {C}_{i}^{j , ref} - ( {c}_{00} + {c}_{01} L a {t}_{i} + {c}_{10} L o {n}_{i} + {c}_{11} L a {t}_{i} L o {n}_{i} + {{c}_{02} ( L a {t}_{i} )}^{2} + {{c}_{20} ( L o {n}_{i} )}^{2} )$ |

$$E [ {ε}_{i}^{j} \cdot {ε}_{i}^{j} ] = {( {σ}_{i}^{j} )}^{2}$$

is the STEC estimation error variance provided by a PPP engine (Algorithm 1, “In”). E[⋅] denotes the first moment of the random variable.

The following assumption is made about a posteriori residuals covariance:

$$E [ {d}_{i}^{j , ref} {d}_{k}^{j , ref} ] = {m}_{i}^{j} {m}_{k}^{j} E [ {δ}_{i}^{j} {δ}_{k}^{j} ] + {m}_{i}^{ref} {m}_{k}^{ref} E [ {δ}_{i}^{ref} {δ}_{k}^{ref} ] - - {m}_{i}^{ref} {m}_{k}^{j} E [ {δ}_{i}^{ref} {δ}_{k}^{j} ] - {m}_{i}^{j} {m}_{k}^{ref} E [ {δ}_{i}^{j} {δ}_{k}^{ref} ] \qquad ( 1 )$$

where

$$E [ {δ}_{i}^{j} {δ}_{k}^{l} ]$$

are calculated according (3).

$$E [ {δ}_{i}^{j} ] = 0 , \qquad ( 2 )$$

A spatial correlation matrix is modelled using a Gaussian kernel:

$$E [ {δ}_{i}^{j} {δ}_{k}^{l} ] = {C}_{0} ( t ) exp ( - \frac{{r}^{2} ( P {P}_{i}^{j} , P {P}_{k}^{l} )}{{R}_{sill}^{2}} ) , \qquad ( 3 )$$

where:
C₀(t)—general ionosphere activity indicator. Can be gathered and calculated in advance.
t—time (UTC hour).
Rₛᵢₗₗ—decorrelation distance (fixed constant);

$$r ( P {P}_{i}^{j} , P {P}_{k}^{l} ) - distance between pierce points for the line of sight from receiver i to satellite j and from receiver k to satellite l .$$

With respect to detector of STEC outliers by satellite (detector 206 shown in FIG. 2), in one embodiment, actual a posteriori differenced STEC residuals dᵢ^{j,ref} are checked to determine if they agree with prior information about ionosphere activity C₀(t). In one embodiment, detector of STEC outliers by detector 206 implements algorithm 3 shown below.

Algorithm 3. Detector of STEC outliers by satellites (206)

| In | $a posteriori residuals of differenced STEC : {d}_{i}^{j , ref} for one satellite j and all receivers$ |
|---|---|
| | $convariance of a posteriori residuals E [ {d}_{i}^{j , r e f} {d}_{i}^{j , ref} ]$ |
| | $variance of STEC estimation error {σ}_{i}^{j}$ |
| | sigma multiplier threshold TH |
| Out | faulty satellite flag |
| | faulty STEC flag |
| | expected value of variance Cₑₓₚ |
| | Algorithm actions sequence |
| 1 | $calculate median of absolute values of {d}_{i}^{j , ref} :$ |
| | $MAD = median ( [ \vert {d}_{1}^{j , ref} \vert , … , \vert {d}_{N}^{j , ref} \vert ] ) ,$ |
| 2 | Calculate expected value of variance: |
| | ${C}_{e x p} = {\sum }_{i = 1}^{N} ( E [ {d}_{i}^{j , ref} {d}_{i}^{j , r e f} ] + {( {σ}_{i}^{j} )}^{2} ) / N$ |
| | Where N - the number of receivers in regional network which were used for interpolation |
| 3 | Exclude from the sample receiver “I” |
| | $if {( \vert {d}_{i}^{j , ref} \vert > 5 * ( 1.4826 * MAD ) and \vert {d}_{i}^{j , ref} \vert > 2 \sqrt{{C}_{exp}} )}^{*}$ |
| | *Thresholds can be set by parameters if ionosphere behavior doesn’t correspond to normal |
| | gaussian distribution even after median calculation of the STEC residuals. |
| 4 | If more than 30% of receivers were excluded, mark satellite “j” as faulty and exit |
| 5 | $Else if MAD > T H * \frac{\sqrt{{C}_{exp}}}{1.4826} mark satellite “ j ” as faulty and exit$ |
| 6 | $Else , mark excluded {STEC}_{i}^{j} as faulty if receiver “ i ” was excluded from sample$ |

With respect to cross validation module 208 shown in FIG. 2, for satellites that are not marked as faulty, cross-validation operation 208 is applied to detect outliers in STEC estimation. In one embodiment, a cross-validation procedure is used to compare STEC values estimated on a certain station with STEC values interpolated between adjacent stations. In one embodiment, cross validation is performed using algorithm 4 below.

Algorithm 4. Cross-validation algorithm for the detection of STEC outliers (208)

| | |
|---|---|
| In | $differenced STEC a posteriori residuals : {d}_{i}^{j , ref} for one satellite j and all reeceivers$ |
| | that are not marked as faulty |
| | ionosphere activity Cₑₓₚ(t) |
| | sigma multiplier threshold TH |
| Out | faulty STEC flag |
| | Algorithm actions sequence |
| 1 | For each available station find stations in vicinity not farther than Rₛᵢₗₗ |
| 2 | Interpolate single-differenced STEC posterior residuals from selected stations using optimal |
| | estimator |
| 3 | Calculate theoretical interpolation error variance |
| 4 | Calculate discrepancy between estimated differenced STEC and interpolated value |
| 5 | If discrepancy at least TH times greater than times larger than theoretical discrepancy |
| | variance, mark STEC as faulty |

With respect to interpolation and accuracy estimation module 210 shown in FIG. 2, after outliers are removed, single-differenced STEC estimations are interpolated onto GRID points using optimal estimator (optimal interpolation algorithm 5) shown below. Calculated covariance matrix

$${C}_{u}^{j , ref}$$

of interpolation errors on defined GRID points is used to calculate expected accuracy at any arbitrary user position. STEC quality indicator for each satellite is calculated as the mean value of RMS obtained from Cᵤ^{j,ref} for evenly distributed points in the service area.

Algorithm 5. Optimal interpolation (210)

| | |
|---|---|
| In | $differenced STEC a posteriori residuals : {d}^{j , ref} - vector of {d}_{i}^{j , ref} values for one$ |
| | satellite pair j and ref for all selected receivers |
| | $differenced STEC estimation variance {( {σ}_{i}^{j} )}^{2}$ |
| | ionosphere activity C₀(t) |
| | interpolation points (grid points) u |
| Out | $interpolated STEC residuals {d}_{u}^{j , ref}$ |
| | $interpolated STEC convariance matrix {C}_{u}^{j , ref}$ |
| | Algorithm actions sequence |
| 1 | $Calculate convariance matrix {C}_{dd}^{j , ref} according to ( 1 )$ |
| 2 | Calculate ionosphere pierce points for interpolation points and satellites j and ref |
| 3 | $Calculate convariance matrix {C}_{uu}^{j , ref} ( convariance at interpolation points ) and$ |
| | ${C}_{du}^{j , ref} ( convariance between receivers and interpolation points ) according to ( 1 )$ |
| 4 | Additional noise of differenced STEC a posteriori residuals is defined by diagonal |
| | $convariance matrix {R}_{dd}^{j , ref} with {( {σ}_{i}^{j} )}^{2} on the diagonal$ |
| 4 | Calculate differenced STEC interpolated values and covariance: |
| | ${d}_{u}^{j , ref} = {( {C}_{du}^{j , ref} )}^{T} \cdot {( {C}_{dd}^{j , ref} + {R}_{dd}^{j , ref} )}^{- 1} {d}^{j , ref}$ |
| | ${C}_{u}^{j , ref} = {C}_{uu}^{j , ref} - {( {C}_{du}^{j , ref} )}^{T} \cdot {( {C}_{dd}^{j , ref} + {R}_{dd}^{j , ref} )}^{- 1} {C}_{du}^{j , ref}$ |

In one embodiment, a STEC value at each GRID point is calculated as the sum of the interpolated residual and approximating surface value at each GRID position (note that surface coefficients are calculated using Algorithm 2).

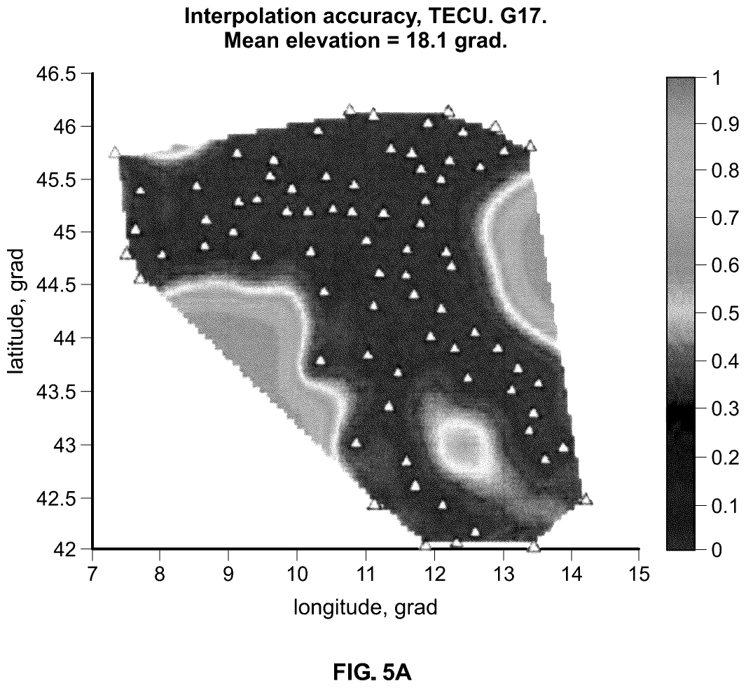

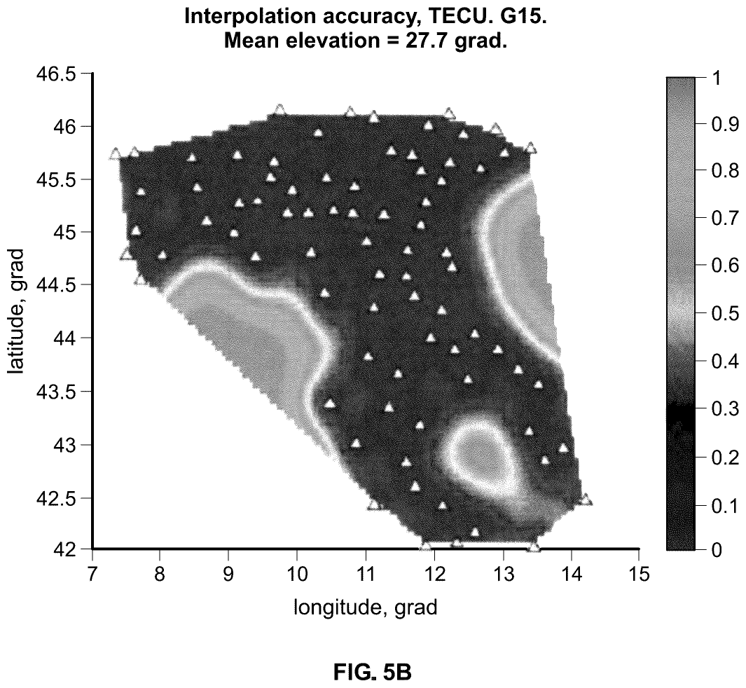

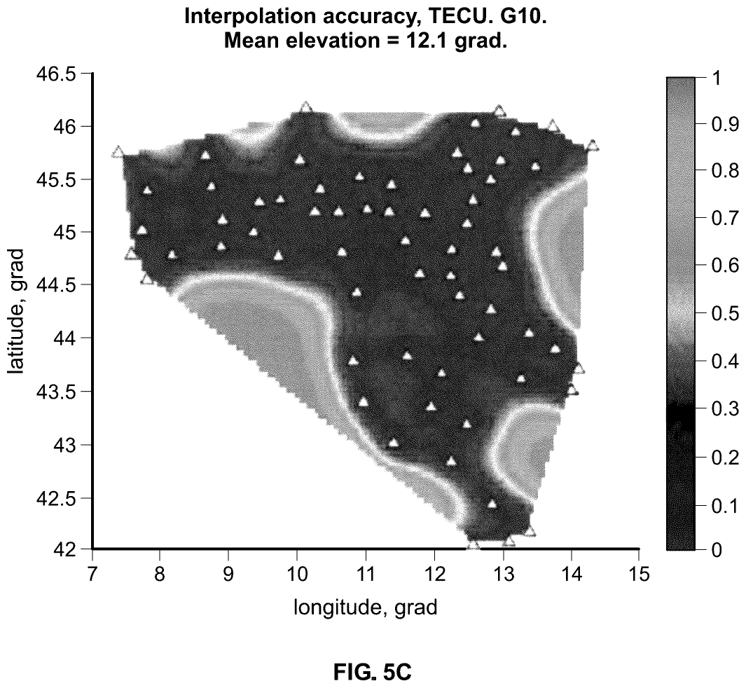

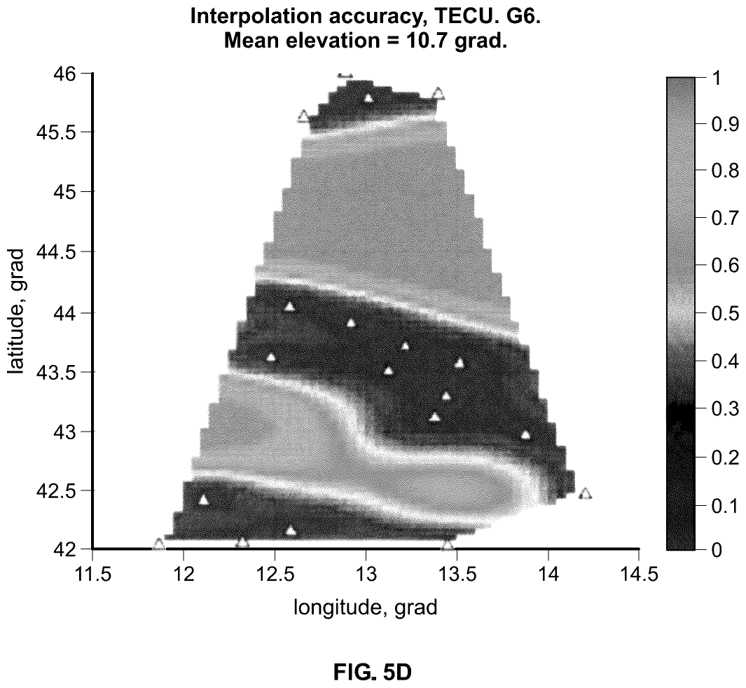

Examples of calculated interpolation accuracy for different satellites at the same epoch are presented in FIGS. 5A-5D. These graphs represent the spatial distribution of interpolation RMS errors in the service area of a regional network. One can see how interpolation accuracy changes with user position and spatial distribution of the stations.

FIG. 5A shows a graph of longitude vs. latitude representing interpolation accuracy in TECU, GPS satellite G17, where the mean elevation is 18.1 grad.

FIG. 5B shows a graph of longitude vs. latitude representing interpolation accuracy in TECU, GPS satellite G15, where the mean elevation is 27.7 grad.

FIG. 5C shows a graph of longitude vs. latitude representing interpolation accuracy in TECU, GPS satellite G10, where the mean elevation is 12.1 grad.

FIG. 5D shows a graph of longitude vs. latitude representing interpolation accuracy in TECU, GPS satellite G6, where the mean elevation is 10.7 grad.

Second version of the ionosphere data processing algorithm 200 of FIG. 2 implies having some prior information about ionosphere activity and this information has been estimated in advance using large volumes of data. In one embodiment, this information is designated as C₀(t).

Significant improvements in terms of interpolation quality and flexibility of algorithm 200 can be achieved if we estimate C₀(t) “on the fly” (i.e., estimated simultaneously with operation of algorithm 200, i.e., first version), using what is referred to as a “slow loop”. The term “slow”, in this case means that the update rate of C₀(t) will be low relative to the overall system functionality update rate because of the time needed for data filtering and to obtain proper results.

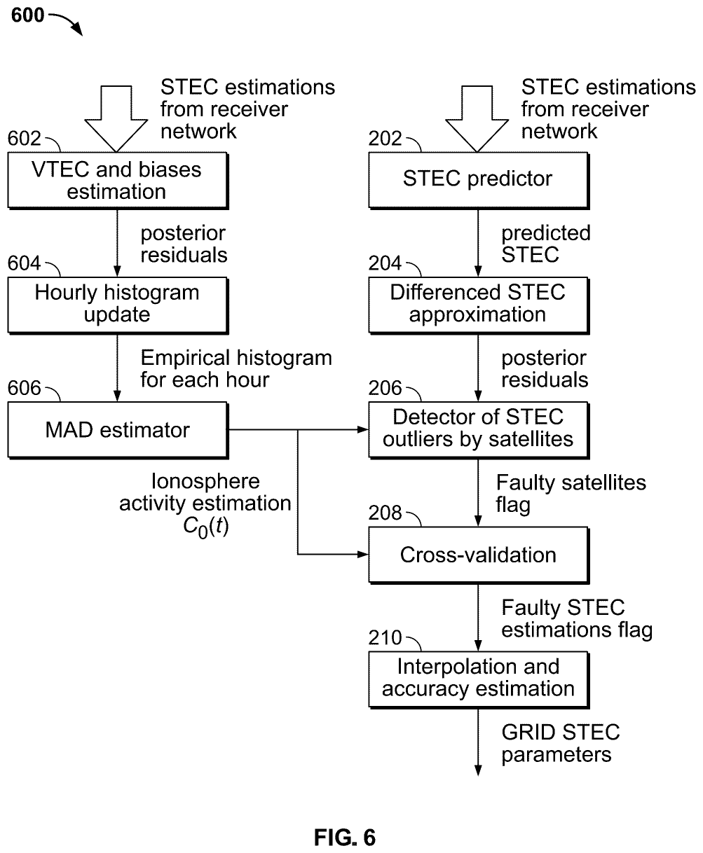

FIG. 6 shows first version of the ionosphere data processing algorithm 600 which has two key features. First, ionosphere data processing algorithm 600 has improved accuracy relative to the previously described second ionosphere data processing algorithm (i.e., algorithm 200 shown in FIG. 2). This is due to the reference surface being calculated on-the-fly and approximating general ionosphere behavior. Secondly, ionosphere data processing algorithm 600 has scalability and flexibility for the deployment in new regional networks. This is because with the first ionosphere data processing algorithm 600, it is no longer necessary to precisely predefine ionosphere conditions in each new network. The ionosphere conditions in each new network will be determined and tuned on-the-fly.

As shown in FIG. 6, the second version of ionosphere data processing algorithm of FIG. 2 is shown on the right side and remains the same as described above in connection with FIG. 2. The first ionosphere data processing algorithm of FIG. 2 is augmented by the operations shown on the left of FIG. 6.

As shown in FIG. 6, STEC estimations from a regional receiver network are input to VTEC and biases estimation module 602 which also outputs a posteriori residuals. A posteriori residuals are input to hourly histogram update module 604 which outputs each hour an empirical histogram. This empirical hourly histogram is input to MAD estimator 606 which estimates and outputs ionosphere activity indicator C₀(t). The ionosphere activity indicator C₀(t) is input to the detector of STEC outliers by satellite module 206 and cross-validation module 208 shown on the right side of FIG. 6 which are also part of the algorithm shown in FIG. 2.

In one embodiment, VTEC and biases estimation module 602 performs algorithm 6 shown below. In one embodiment, VTEC estimates within regional network of base stations are modelled as a 2nd order surface and additive stationary gaussian process with spatial correlation:

$$V T E {C}_{i}^{j} = {c}_{00} + {c}_{01} {Lat}_{pp , i}^{j} + {c}_{10} {Lon}_{pp , i}^{j} + {c}_{11} {Lat}_{pp , i}^{j} {Lon}_{pp , i}^{j} + {{c}_{02} ( {Lat}_{pp , i}^{j} )}^{2} + {{c}_{20} ( {Lon}_{pp , i}^{j} )}^{2} + {δ}_{i}^{j}$$

where c₀₀, c₀₁, c₁₀, c₁₁, c₀₂, c₂₀ are coefficients to be estimated;

$${Lat}_{pp , i}^{j} and {Lon}_{pp , i}^{j}$$

are latitude and longitude of the pierce point associated with receiver i and satellite j;

$${δ}_{i}^{j}$$

are random values with zero mean: ionosphere approximation surface coefficients c₀₀, . . . , c₂₀ are estimated along with biases Δᵢ and μ^{j} using robust estimator with iterative reweighting.

Algorithm 6. Robust estimator with iterative reweighting (602)

| | |
|---|---|
| In | $estimated {STEC}_{i}^{j} ,$ |
| | $pierce points coordinates {Lat}_{pp , i}^{j} and {Lon}_{pp , i}^{j}$ |
| | deweighting threshold TH |
| Out | Approximation of the VTEC surface coefficients c₀₀, cₒ₁, c₁₀, c₁₁, c₀₂, c₂₀. |
| | A posteriori VTEC residuals δᵢ^{j} |
| | Estimation of the biases Δᵢ, μ^{j}. |
| | Algorithm actions sequence |
| 1 | Collect estimated by receivers STECᵢ^{j} values to one measurements vector z |
| 2 | Construct observation matrix H in accordance with the STEC to VTEC transition model |
| | (estimated STEC general model) and VTEC model (performed by VTEC and biases |
| | estimation module). Each row of the H matrix consists of the coefficients: |
| | ${h}_{i}^{j} = [ {m}_{i}^{j} , {m}_{i}^{j} {Lat}_{pp , i}^{j} , {m}_{i}^{j} {Lon}_{pp , i}^{j} , {m}_{i}^{j} ( {Lat}_{pp , i}^{j} {Lon}_{pp , i}^{j} ) , {{m}_{i}^{j} ( {Lat}_{pp , i}^{j} )}^{2} , {{m}_{i}^{j} ( {Lon}_{pp , i}^{j} )}^{2} , {1}_{N} ( i ) , {1}_{M} ( j ) ]$ |
| | Where: |
| | 1_{N}(i) - is a row-vector of length N with all elements equal to 0 excluding element with |
| | index i which is equal to 1. |
| | N - is the total number of active receivers in the network. |
| | M - is the total number of satellites. To make the system observable one of the satellites for |
| | each station is chosen as reference satellite and instead of receiver bias Δᵢ the difference |
| | (Δᵢ - μ^{ref}) is estimated. |
| 3 | Set initial weights for all measurement: w(:) = 1; |
| 4 | Calculate weight matrix W: W = diag(w)/sum(w); |
| 5 | Calculate state estimation: x = (H′*W\hat{ }2*H)\H′*W\hat{ }2*z; |
| 6 | Calculate a posteriori residuals: r = abs(z - H*x); |
| 7 | Identify outliers: badsat = (r > TH); |
| 8 | Update weights: |
| | w(:)= 1; |
| | w(badsat) = sqrt(2*r(badsat)*TH - TH\hat{ }2)./r(badsat); |
| 9 | Iterative repetition of the steps 4-8 until r < TH or iterations > 3 |
| 10 | Calculate a posteriori residuals: |
| | ${δ}_{i}^{j} = ( {STEC}_{i}^{j} - {Δ}_{i} - {μ}^{j} ) / {m}_{i}^{j} - ( {c}_{00} + {c}_{01} {Lat}_{pp , i}^{j} + {c}_{10} {Lon}_{pp , i}^{j} + {c}_{11} {Lat}_{pp , i}^{j} {Lon}_{pp , i}^{j} + {{c}_{02} ( {Lat}_{pp , i}^{j} )}^{2} + {{c}_{20} ( {Lon}_{pp , i}^{j} )}^{2} )$ |

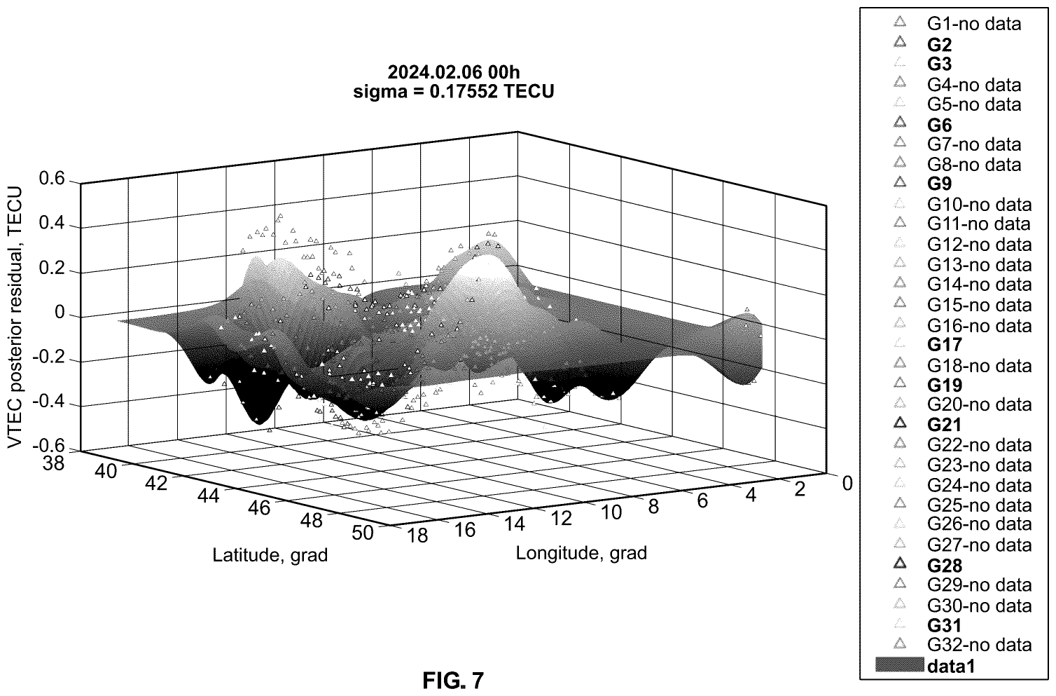

FIG. 7 shows graph 700 of a posteriori VTEC residuals during night hours (low ionosphere activity).

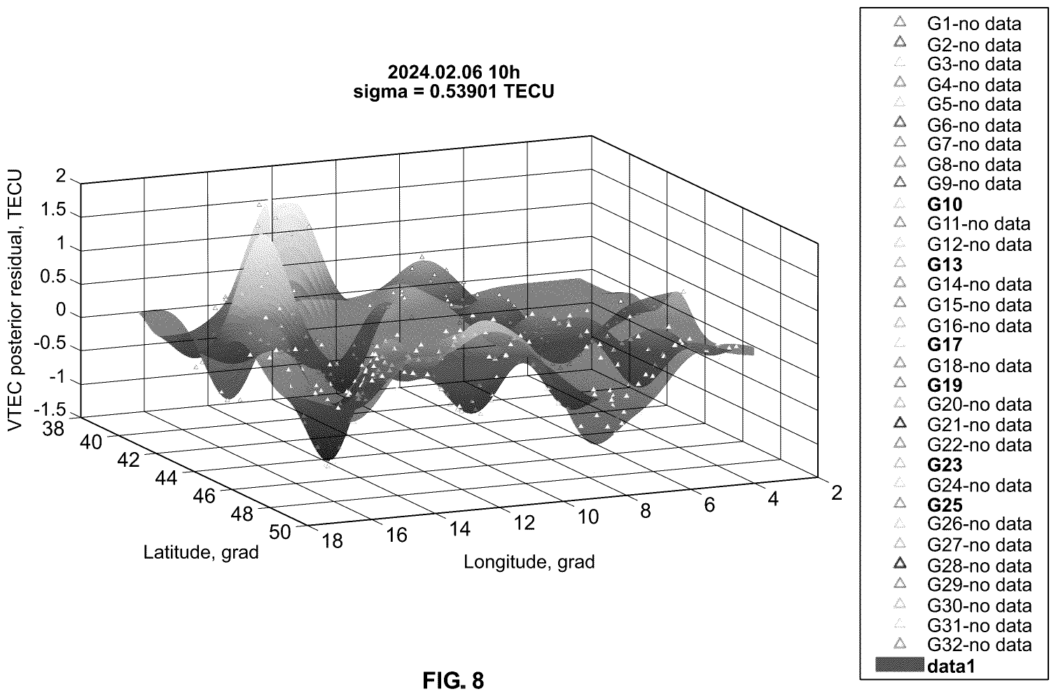

FIG. 8 shows graph 800 of a posteriori VTEC residuals during morning hours (high ionosphere activity).

Returning to FIG. 6, a posteriori residuals δᵢ^{j} of the bias estimation process 602 are used to generate hourly histograms updated in module 604. On the basis of these histograms, covariance matrix parameter C₀(t) is computed. In one embodiment, only points associated with a distance longer than Rₛᵢₗₗ (assuming they are not correlated) and with of less than a threshold value are selected for the histogram and can contribute to C₀(t). This empirical histogram is an array of bins with associated weights. All the bins are of equal width. The lower bound (left-most) is defined as 0, while the higher bound (right-most) is set in accordance with the worst-case expectations. Recommended value for the higher bound is 100 TECU and the recommended bin width is 0.5 TECU. On each update step the sum of bin weights is normalized to 1. The histogram is updated according to steps 2-4 of Algorithm 7.

In one embodiment, C₀(t) is estimated using Algorithm 7 below.

Algorithm 7. MAD estimator of ionosphere variance (604,606)

| | |
|---|---|
| In | $posterior VTEC residuals {δ}_{i}^{j} ,$ |
| | distances between pierce points |
| Out | empirical histogram of variance estimations for each UTC hour (0-23) |
| | variance estimation for current hour |
| Initial | Define empirical histogram bins edges. For each hour equal set of bins is created (overall |
| state | 24 sets of bins). Denote B(t) - bins set associated with the current hour t. |
| | For each t set Nₕᵢₛₜ(t) = 0 |
| 1 | $Calculate absolute difference between all selected residuals pairs : {Δ}_{ik}^{jl} = \vert {δ}_{i}^{j} - {δ}_{k}^{l} \vert$ |
| 2 | $Recalculate weights of all bins in the set B ( t ) : {w}_{b} = {w}_{b} \frac{{N}_{hist} ( t )}{{N}_{hist} ( t ) + {N}_{new}}$ |
| | $for each b ∈ B ( t ) , where {N}_{new} - number of differences {Δ}_{ik}^{jl} ,$ |
| 3 | $For each {Δ}_{ik}^{jl} :$ |
| | $a . Find the bin b with left edge less than {Δ}_{ik}^{jl} and right edge larger than {Δ}_{ik}^{jl}$ |
| | $Increase weight of the bin {w}_{b} = {w}_{b} + \frac{1}{{N}_{hist} ( t ) + {N}_{new}}$ |
| 4 | b. Update Nₕᵢₛₜ(t): Nₕᵢₛₜ(t) = Nₕᵢₛₜ(t) + N_{new} |
| 5 | Calculate approximated value of Median Absolute Deviation (MAD) using empirical |
| | histogram B(t) |
| 6 | Calculate estimation of VTEC spatial variance: |
| | ${C}_{0} ( t ) = \frac{{( 1 \text{.4826} \cdot M A D )}^{2}}{2}$ |

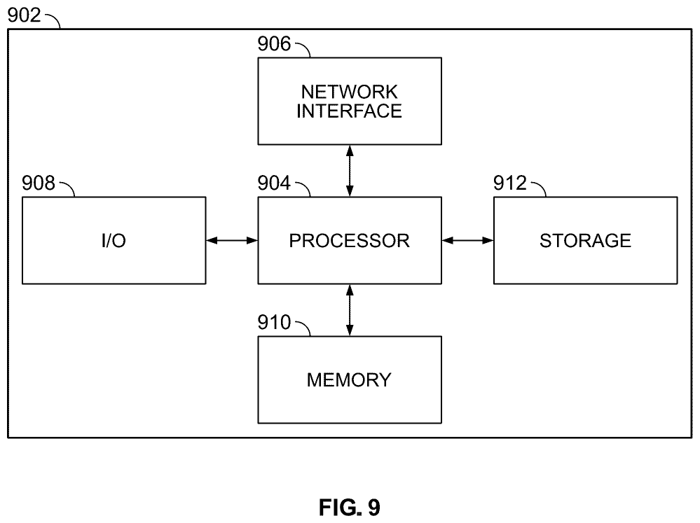

In one embodiment, STEC processor 102 is implemented using a computer. Other methods, techniques, and algorithms described herein can also be implemented using a computer. A high-level block diagram of such a computer is illustrated in FIG. 9. Computer 902 contains a processor 904 which controls the overall operation of the computer 902 by executing computer program instructions which define such operation. The computer program instructions may be stored in a storage device 912, or other computer readable medium (e.g., magnetic disk, CD ROM, etc.), and loaded into memory 910 when execution of the computer program instructions is desired. Thus, the method steps of FIGS. 2 and 6 can be defined by the computer program instructions stored in the memory 910 and/or storage 912 and controlled by the processor 904 executing the computer program instructions. For example, the computer program instructions can be implemented as computer executable code programmed by one skilled in the art to perform an algorithm defined by the method steps of FIGS. 2 and 6. Accordingly, by executing the computer program instructions, the processor 1004 executes an algorithm defined by the method steps of FIGS. 2 and 6. The computer 902 also includes one or more network interfaces 906 for communicating with other devices via a network. The computer 902 also includes input/output devices 908 that enable user interaction with the computer 902 (e.g., display, keyboard, mouse, speakers, buttons, etc.) One skilled in the art will recognize that an implementation of an actual computer could contain other components as well, and that FIG. 9 is a high-level representation of some of the components of such a computer for illustrative purposes.

The foregoing Detailed Description is to be understood as being in every respect illustrative and exemplary, but not restrictive, and the scope of the inventive concept disclosed herein is not to be determined from the Detailed Description, but rather from the claims as interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method for fast precise service, the method comprising:
receiving Slant Total Electron Content (STEC) estimations from a network of Global Navigation Satellite System (GNSS) receivers;
generating a predicted STEC based on the STEC estimations;
generating a differenced STEC spatial approximation based on the predicted STEC;
raising a faulty satellite flag in response to detection of STEC outliers based on a posteriori residuals of the differenced STEC spatial approximation;
raising a faulty STEC estimations flag in response to cross-validation of STEC values;
generating grided STEC parameters based on interpolation and accuracy estimation; and
transmitting high quality fault-free grided STEC parameters to a Global Positioning System user receiver to provide fast precise point positioning solution.

2. The method of claim 1, wherein the generating a predicted STEC comprises:
detecting STEC outliers in the STEC estimations;
filtering out the detected STEC outliers in the STEC estimations and replacing them with extrapolated values; and
replacing short time gaps with extrapolated values.

3. The method of claim 1, wherein the generating a predicted STEC comprises:
filtering STEC estimations using a modified Alpha-Beta filter.

4. The method of claim 1, wherein the cross-validation of STEC values comprises:
comparing STEC values estimated on a particular station with STEC values interpolated between adjacent stations.

5. The method of claim 1, further comprising:
generating an estimation of ionosphere activity indicator,
wherein the detection of STEC outliers and cross-validation of STEC values are further based on the estimation of ionosphere activity indicator.

6. The method of claim 5, wherein the generating an estimation of ionosphere activity indicator comprises:
generating a posteriori residuals of a VTEC and biases estimation process;
generating hourly empirical histograms based on the a posteriori residuals; and
estimating a time-dependent ionosphere activity indicator based on hourly empirical histograms.

7. The method of claim 6, wherein generating a faulty satellite flag in response to detection of STEC outliers based on the a posteriori residual of differenced STEC spatial approximation process.

8. The method of claim 7, wherein a faulty estimation flag is raised based on the cross-validation of STEC values and the ionosphere activity indicator.

9. An apparatus for precise point positioning, the apparatus comprising:
a processor; and
a memory to store computer program instructions, which, when executed on the processor cause the processor to perform operations comprising:
receiving Slant Total Electron Content (STEC) estimations from a receiver network;
generating a predicted STEC based on the STEC estimations;
generating a differenced STEC spatial approximation based on the predicted STEC;
raising a faulty satellite flag in response to detection of STEC outliers based on a posteriori residuals of the approximation;
raising a faulty STEC estimations flag in response to cross-validation of STEC values;
generating GRID STEC parameters based on interpolation and accuracy estimation; and
transmitting the GRID STEC parameters to a user receiver.

10. The apparatus of claim 9, wherein the generating a predicted STEC comprises:
detecting STEC outliers in the STEC estimations;
filtering out the detected STEC outliers in the STEC estimations and replacing them with extrapolated values; and
replacing short time gaps with extrapolated values.

11. The apparatus of claim 9, wherein the generating a predicted STEC comprises:
filtering STEC estimations using a modified Alpha-Beta filter.

12. The apparatus of claim 9, wherein the cross-validation of STEC values comprises:
comparing STEC values estimated on a certain station with STEC values interpolated between adjacent stations.

13. The apparatus of claim 9, the operations further comprising:
generating an estimation of ionosphere activity indicator,
wherein the detection of STEC outliers and cross-validation of STEC values are further based on the estimation of ionosphere activity indicator.

14. The apparatus of claim 13, wherein the generating an estimation of ionosphere activity indicator comprises:
generating a posteriori residuals of a VTEC and biases estimation process;
generating hourly empirical histograms based on the a posteriori residuals; and
estimating a time-dependent ionosphere activity indicator based on hourly empirical histograms.

15. A computer readable medium storing computer program instructions for precise point positioning, which, when executed on a processor, cause the processor to perform operations comprising:
receiving Slant Total Electron Content (STEC) estimations from a receiver network;
generating a predicted STEC based on the STEC estimations;
generating a differenced STEC spatial approximation based on the predicted STEC;
raising a faulty satellite flag in response to detection of STEC outliers based on the a posteriori residuals of the approximation;
raising a faulty STEC estimations flag in response to cross-validation of STEC values;
generating GRID STEC parameters based on interpolation and accuracy estimation; and
transmitting the GRID STEC parameters to a user receiver.

16. The computer readable medium of claim 15, wherein the generating a predicted STEC comprises:
detecting STEC outliers in the STEC estimations;
filtering out the detected STEC outliers in the STEC estimations and replacing them with extrapolated values; and
replacing short time gaps with extrapolated values.

17. The computer readable medium of claim 15, wherein the generating a predicted STEC comprises:
filtering STEC estimations using a modified Alpha-Beta filter.

18. The computer readable medium of claim 15, wherein the cross-validation of STEC values comprises:
comparing STEC values estimated on a particular station with STEC values interpolated between adjacent stations.

19. The computer readable medium of claim 15, the operations further comprising:
generating an estimation of ionosphere activity indicator,
wherein the detection of STEC outliers and cross-validation of STEC values are further based on the estimation of ionosphere activity indicator.

20. The computer readable medium of claim 19, wherein the generating an estimation of ionosphere activity indicator comprises:
generating a posteriori residuals of a VTEC and biases estimation process;
generating hourly empirical histograms based on the a posteriori residuals; and
estimating a time-dependent ionosphere activity indicator based on hourly empirical histograms.
